(19) United States
(12) Patent Application Publication
(10) Pub. No.: US 2014/0193985 A1
(43) Pub. Date: Jul. 10, 2014

(54) ELECTRICALLY CONDUCTIVE CONNECTING MEMBER, METHOD OF FORMING AND USING THE SAME

(71) Applicant: PIONEER MATERIAL PRECISION TECH CO., LTD., New Taipei City (TW)

(72) Inventors: Peng-Cheng Wang, Kaohsiung City (TW); Yuan-Shun Tsai, New Taipei City (TW); Yi-Lun Chen, New Taipei City (TW)

(73) Assignee: PIONEER MATERIAL PRECISION TECH CO., LTD., New Taipei City (TW)

(21) Appl. No.: 14/151,826

(22) Filed: Jan. 10, 2014

Related U.S. Application Data
(60) Provisional application No. 61/750,817, filed on Jan. 10, 2013.

(51) Int. Cl. H01R 13/03; H01R 13/24

(52) U.S. Cl. CPC H01R 13/03; H01R 13/2414; Y10S 977/932; B82Y 30/00
USPC 439/66; 439/86; 264/104; 977/932

(57) ABSTRACT

An electrically conductive connecting member includes an electrically insulating elastomer and an electrically conducting elastomer. The conductive connecting member has a Shore Hardness type A from 5 to 90 degrees, water-resistant ability up to 0.1 kgf/cm² and 10%˜20% compression set. The conductive connecting member is capable of remaining good resilience, water-resistance and electric conductivity after long term use.

### CROSS REFERENCE TO RELATED APPLICATIONS

This application claims the benefit of U.S. Provisional Application Ser. No. 61/750,817, filed Jan. 10, 2013.

### BACKGROUND OF THE INVENTION

1. Field of the Invention

The present invention generally relates to an electrically conductive connecting member, a method for forming an electrically conductive connecting member and a method for using an electrically conductive connecting member. In particular, the present invention is direct to an electrically conductive connecting member which includes an electrically conducting elastomer by curing a liquid polymeric material, a method for forming an electrically conductive connecting member and a method for using an electrically conductive connecting member. The electrically conductive connecting member of the present invention may serve as a conductive connecting member in an electronic part set of small size.

2. Description of the Prior Art

Each single part is located everywhere in an electronic part set. Because each electronic part is not resilient, there are gaps of various sizes and shapes amongst each part. An elastomeric material of electrically conductive connecting functions is used to fill the gaps and to serve a current path. So far the commercial available products are either an electrically conductive fabric made of traditional polyethylene terephthalate or a foam product with polyurethane covered by the electrically conductive fabric. However, because the foam or the electrically conductive fabric made of traditional polyethylene terephthalate is not elastic, they are susceptible to a permanent deformation after long term compressed usage.

In addition to this, the commercial available electrically conductive connecting products are solid products made of solid materials. In order to decrease the electric resistivity, a great deal of conductive additives are used. However, the more the conductive additives are added, the harder the solid elastomer material will be, which renders them less convenient to go with a smaller mold. Accordingly, the shapes or the sizes of the shaped electrically conductive connecting member are restricted. For example, the exposed surface area is not less than 50 mm².

### SUMMARY OF THE INVENTION

In the light of the above drawbacks, the present invention proposes an electrically conductive connecting member along with a method for forming an electrically conductive connecting member and a method for using an electrically conductive connecting member. The electrically conductive connecting member is made by curing a liquid electrically conducting elastomer material and a solid electrically insulating elastomer material. The electrically insulating elastomer material is based on a solid polysiloxane material and the electrically conducting elastomer material is based on a liquid polysiloxane material but the electrically insulating elastomer material and the electrically conducting elastomer material respectively have extremely high and low electric resistivity. The electrically conducting elastomer material of a liquid polysiloxane material flows more easily so it is easier to fill a space of smaller size. Accordingly, the formed electrically conducting elastomer may have an exposed surface area as small as 50-0.5 mm². In addition, the electrically conductive connecting member has a Shore Hardness type A from 5 to 90 degrees, the water-resistant ability up to 0.1 kgf/cm² and/or 10%˜20% compression set. It is suitable to fill the gaps in an electronic part set.

The present invention in a first aspect proposes an electrically conductive connecting member. The electrically conductive connecting member includes an electrically conducting elastomer attached to an electrically insulating elastomer. The electrically insulating elastomer has a cavity and at least one opening, and a first silicone-rubber-based material of a first polysiloxane. The first silicone-rubber-based material includes 99.99 wt. %-10 wt. % of the first polysiloxane, based on the total weight of the electrically insulating elastomer, and 0.01 wt. %-10 wt. % of a curing agent based on the total weight of the electrically insulating elastomer. The electrically conducting elastomer fills the opening, fills up the cavity and includes 5 wt. %-80 wt. % of a conductive additive, based on the total weight of the electrically conducting elastomer, and a second silicone-rubber-based material of a second polysiloxane material. The second silicone-rubber-based material includes 94.99 wt. %-10 wt. % of the second polysiloxane material based on the total weight of the electrically conducting elastomer and 0.01 wt. %-10 wt. % of a platinum curing agent, based on the total weight of the electrically conducting elastomer.

In one embodiment of the present invention, the first silicone-rubber-based material includes at least one of a platinum curing agent and a peroxide curing agent.

In another embodiment of the present invention, the first silicone-rubber-based material or the second silicone-rubber-based material may further include at least one material selected from the group of diatomite, titanium dioxide, aluminum oxide, boron nitride, aluminum nitride, zinc oxide, aluminum hydroxide, magnesium oxide, silicon oxide and silicone oil.

In another embodiment of the present invention, the conductive additive may include at least one material selected from the group of silver coated glass beads, nickel carbide and carbon nanotubes.

In another embodiment of the present invention, the electrically insulating elastomer has a volume resistivity greater than 10¹² ohm*cm.

In another embodiment of the present invention, the electrically conducting elastomer has a volume resistivity less than 0.5 ohm*cm.

In another embodiment of the present invention, the electrically conducting elastomer which is not covered by the electrically insulating elastomer has a single side surface area of 50-0.5 mm².

In another embodiment of the present invention, the electrically conductive connecting member has a Shore Hardness type A from 5 to 90 degrees.

In another embodiment of the present invention, the electrically insulating elastomer is in a form of a long strip.

In another embodiment of the present invention, the electrically conducting elastomer is in a form of a plurality of isolated island-like units.

In another embodiment of the present invention, the electrically conductive connecting member has 10%˜20% compression set according to ASTM D 395.

In another embodiment of the present invention, the electrically conductive connecting member has a water-resistant ability up to 0.1 kgf/cm².

The present invention in a second aspect proposes a method for forming an electrically conductive connecting member. First, a solid electrically insulating elastomer material including a first silicone-rubber-based material including a solid polysiloxane material is provided. Second, a liquid electrically conducting elastomer material includes a conductive additive and a second silicone-rubber-based material which includes a liquid polysiloxane material is provided. Then, the liquid electrically conducting elastomer material is cured to physically or chemically attach the liquid electrically conducting elastomer material to the solid electrically insulating elastomer material to obtain an electrically conductive connecting member.

In one embodiment of the present invention, the first silicone-rubber-based material further includes at least one of a platinum curing agent and a peroxide curing agent.

In another embodiment of the present invention, the first silicone-rubber-based material or the second silicone-rubber-based material further include at least one material selected from the group of diatomite, titanium dioxide, aluminum oxide, boron nitride, aluminum nitride, zinc oxide, aluminum hydroxide, magnesium oxide, silicon oxide and silicone oil.

In another embodiment of the present invention, the second silicone-rubber-based material further includes 0.01 wt. %-10 wt. % of a platinum curing agent, based on the total weight of the electrically conducting elastomer material.

In another embodiment of the present invention, the method further includes to compound the second silicone-rubber-based material to be the liquid electrically conducting elastomer material.

In another embodiment of the present invention, the conductive additive includes at least one conductive material selected from the group of silver coated glass beads, nickel carbide and carbon nanotubes.

In another embodiment of the present invention, the method further includes to cure the solid electrically insulating elastomer material under a temperature of 80° C. to 220° C. and a pressure of 20 kgf/cm²-200 kgf/cm² to obtain an electrically insulating elastomer including a cavity and at least one opening which has an area of 50-0.5 mm².

In another embodiment of the present invention, the liquid electrically conducting elastomer material fills the at least one opening and fills up the cavity.

In another embodiment of the present invention, curing the liquid electrically conducting elastomer material is carried out under a temperature of 80° C. to 220° C. and a pressure of 20 kgf/cm²-200 kgf/cm² so that the liquid electrically conducting elastomer material is physically or chemically attached to the electrically insulating elastomer.

The present invention in a third aspect proposes a method for using an electrically conductive connecting member. First, an electrically conductive connecting member is provided. The electrically conductive connecting member includes an electrically insulating elastomer and an electrically conducting elastomer as described above. Second, an electronic part set having a gap is provided. Then, the electrically conductive connecting member is pressed into the gap to fill the gap.

In one embodiment of the present invention, the conductive additive includes at least one of material selected from silver coated glass beads, nickel carbide and carbon nanotubes.

In another embodiment of the present invention, the electrically conductive connecting member has a water-resistant ability up to 0.1 kgf/cm².

In another embodiment of the present invention, the electrically conductive connecting member has 10%˜20% compression set according to ASTM D 395.

In another embodiment of the present invention, the electrically conducting elastomer which is not surrounded by the electrically insulating elastomer has a single side surface area of 50-0.5 mm².

In another embodiment of the present invention, a contact area of the electrically conducting elastomer in contact with the electronic part set is at least 0.5 mm² when the electrically conductive connecting member fills the gap.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-6 illustrate a proposed method of forming a conductive connecting member of the present invention.

FIGS. 7-8 illustrate a formed conductive connecting member of the present invention.

FIGS. 9-10 illustrate some examples of the conductive elastomer attached to the insulating elastomer of the present invention.

FIG. 11 illustrates an installation for the water-resistant test.

FIG. 12-13 illustrate a method of using a conductive connecting member of the present invention in an electronic part set to at least fill a gap.

### DETAILED DESCRIPTION

The present invention provides a conductive connecting member along with a method for forming a conductive connecting member and a method for using a conductive connecting member. The conductive connecting member includes a conductive elastomer and an insulating elastomer. The insulating elastomer includes a first silicone-rubber-based material of a first polysiloxane polymeric material, preferably with a cavity and at least one opening which has an area of 50-0.5 mm². The conductive elastomer includes a conductive additive and a second silicone-rubber-based material of a second polysiloxane polymeric material, preferably filling the cavity and filling up the at least one opening. The insulating elastomer and the conductive elastomer respectively have an extremely high and low electric resistivity. The conductive connecting member has a Shore Hardness type A from 5 to 90 degrees, the water-resistant ability up to 0.1 kgf/cm² and 10%˜20% compression set so it is suitable to fill the gaps in an electronic part set.

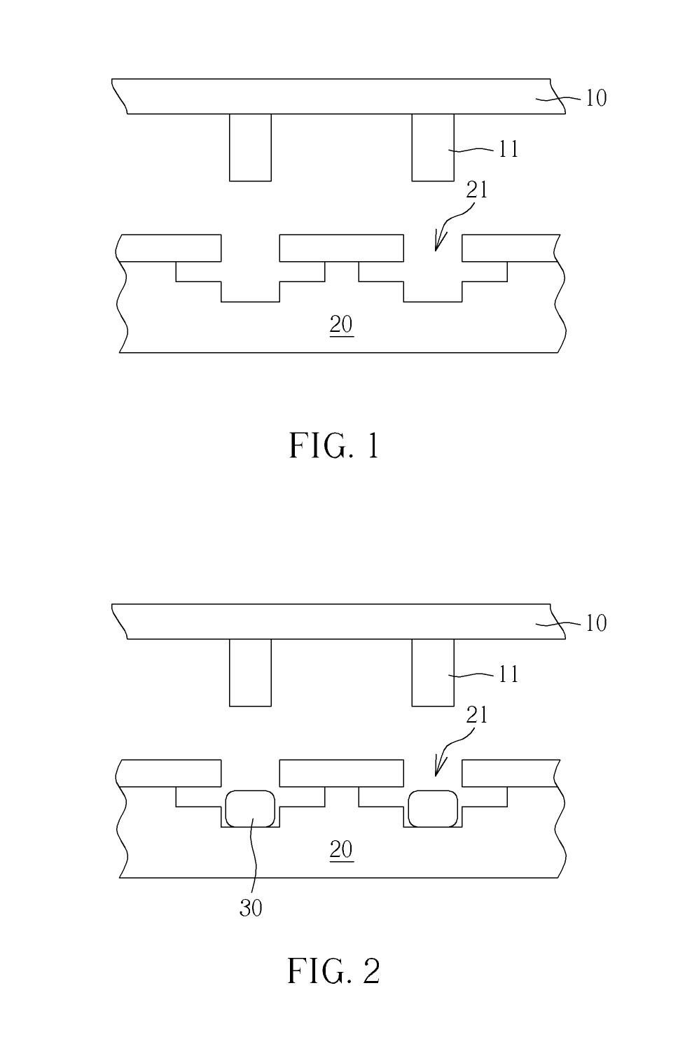

FIG. 1 to FIG. 6 illustrate a method for forming a conductive connecting member. The conductive connecting member is at least electrically conductive. First, a solid insulating elastomer material and a liquid conductive elastomer material are provided. The solid insulating elastomer material is at least electrically insulating and the liquid conductive elastomer material is at least electrically conductive. The solid insulating elastomer material includes a first silicone-rubber-based material based on a first polysiloxane polymeric material.

To prepare an insulating elastomer, the first silicone-rubber-based material may be obtained by reacting a first polysiloxane polymeric material serving as a substrate, a platinum curing agent and/or a peroxide to serves as a curing agent to undergo a curing reaction, and an optional filler in a curing reaction. The first polysiloxane polymeric material itself is a monomeric unit and a functional organic polysiloxane which includes at least one silicon atom connected to an alkoxy group, to a hydroxyl group or to a functional group. The first polysiloxane polymeric material for example, may be polymethylsiloxane, polyvinylmethylsiloxane, polyphenylvinylmethylsiloxane, or polyfluorvinylmethylsiloxane. Depending on different degree of polymerization, molecular weight, or molecular configurations, the Shore Hardness type A of the polymeric material is not essential before curing but the Shore Hardness type A after curing may be 5 to 90 degrees. The content of the first polysiloxane polymeric material may be 99.99 wt. %-10 wt. %, based on the total weight of the insulating elastomer.

The total content of different curing agents may be 0.01 wt. %-10 wt. %, based on the total weight of the insulating elastomer. The peroxide curing agent may be Benzoperoxide, Dicumyl peroxide. The platinum curing agent may be a combination of a first agent which includes platinum to serve as a catalyst agent and a second agent which includes siloxane to serve as a crosslinking agent. Preferably, the insulating elastomer may be attached to the conductive elastomer better when a platinum curing agent of the same kind is used in both the insulating elastomer and the conductive elastomer.

The optional filler may be at least one of the materials selected from the group of diatomite, titanium dioxide, aluminum oxide, boron nitride, aluminum nitride, zinc oxide, aluminum hydroxide, magnesium oxide, silicon oxide and silicone oil. The total content of the optional filler may be up to 80 wt. %, based on the total weight of the insulating elastomer. Some example compositions of insulating elastomers are listed in Table 1.

TABLE 1

| | Example 1 | | Example 2 | | Example 3 | |
|---|---|---|---|---|---|---|
| first | polydimethyl- | | polydimethyl- | | polydimethyl- | |
| polysiloxane | siloxane 70% | | siloxane 90% | | siloxane 50% | |
| polymeric | (Shore A | | (Shore A | | (Shore A | |
| material | 40 degrees) | | 30 degrees) | | 20 degrees) | |
| curing agent | Benzoperoxide | | Dicumyl peroxide | | platinum | |
| | 8% | | 10% | | curing agent: | |
| | | | | | catalyst 10% | |
| | | | | | crosslinking | |
| | | | | | 5% | |
| filler | silicon oxide | | N/A | | silicon oxide | |
| | 22% | | | | 35% | |
| Shore A after | 60 | degrees | 30 | degrees | 30 | degrees |
| formed | | | | | | |
| temperature | 140° C. | | 140° C. | | 130° C. | |
| pressure | 100 | kgf/cm² | 100 | kgf/cm² | 100 | kgf/cm² |
| time | 12 | minutes | 10 | minutes | 8 | minutes |

As shown in FIG. 1, to prepare an insulating elastomer, a preliminary mold 10 and a bottom mold 20 in accordance with the design of the products are provided and a conventional compressing molding machine is used. The bottom mold 20 has a space 21 to accommodate an elastomer material and the extension part 11 of the preliminary mold 10. The preliminary mold 10 and the bottom mold 20 are heated to a pre-determined temperature, such as 140° C.

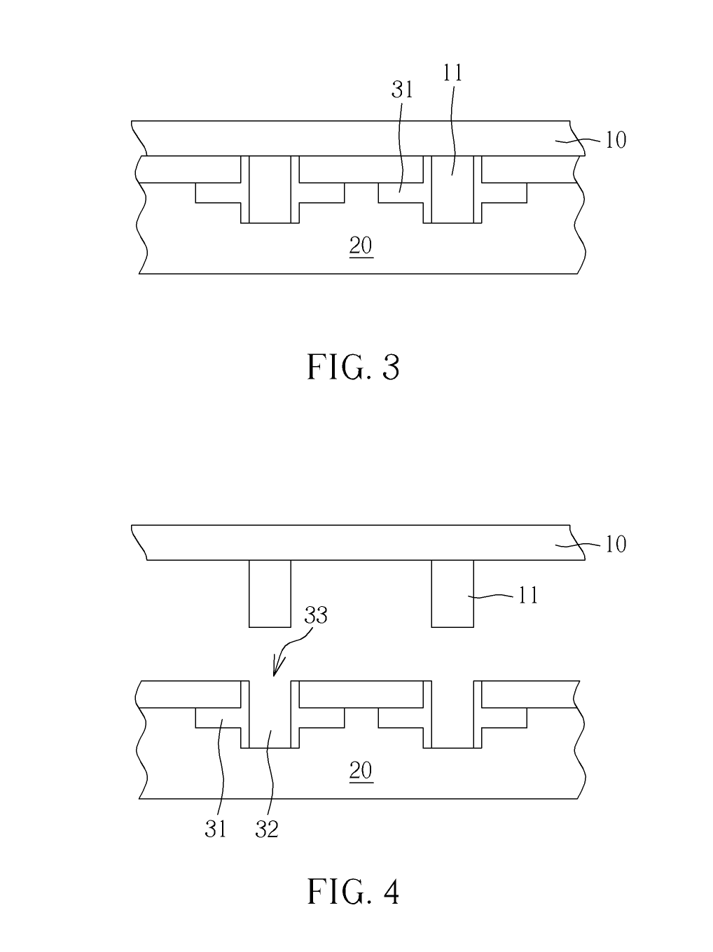

Second, as shown in FIG. 2, a mixed insulating elastomer material 30 as presented above, for example 10 g, is placed in the space 21 of the bottom mold 20. An ideal amount of the insulating elastomer material 30 fills up the space when the preliminary mold 10 and the bottom mold 20 join together, as shown in FIG. 3, to be an insulating elastomer 31.

After cured under a temperature, a pressure and a period of time in a condition such as 80° C. to 220° C. and 20 kgf/cm²-200 kgf/cm², for example, a temperature of 140° C. and a pressure of 100 kgf/cm² for 10 minutes, the preliminary mold 10 is removed to obtain a formed insulating elastomer 31, as shown in FIG. 4. The formed insulating elastomer 31 has a cavity 32 and at least one opening 33 connected to the cavity 32. The cavity 32 is used to accommodate the later-introduced liquid conductive elastomer material. The opening 33 may have an area of 50-0.5 mm².

Next, a liquid conductive elastomer material is prepared. The liquid conductive elastomer material is at least electrically conductive. The liquid conductive elastomer material includes 5 wt. %-80 wt. % of a conductive additive and a second silicone-rubber-based material which is based on a second polysiloxane polymeric material. On one hand, the second silicone-rubber-based material of the liquid conductive elastomer material includes 94.99 wt. %-10 wt. % of a second polysiloxane material and 0.01 wt. %-10 wt. % of a platinum curing agent, all based on the total weight of the electrically conducting elastomer. The second polysiloxane polymeric material itself is a monomeric unit and a functional organic polysiloxane which includes at least one silicon atom connected to an alkoxy group, to a hydroxyl group or to a functional group, such as polymethylsiloxane, polyvinylmethylsiloxane, or polyphenylvinylmethylsiloxane. Depending on different degree of polymerization, molecular weight, or molecular configurations, the viscosity may be 100-2000 Pa*s at 20° C. and at a shearing rate of 10 s⁻¹.

The conductive elastomer may be made by mixing the second silicone-rubber-based material and a conductive additive. The conductive additive may be at least one conductive material, such as selected from the group of silver coated glass beads, nickel carbide and carbon nanotubes. The content of the total conductive additive may be 5 wt. %-80 wt. %, based on the total weight of the conductive elastomer. The electric resistivity of the second silicone-rubber-based material is lowered to form the conductive elastomer when mixed with the conductive additive. The example compositions and the electric resistivity after formation are listed in Table 2. The silver coated glass beads may be the silver coated glass beads (S-3000-S3M, from Potters) with an average particle size of 41 μm. Some common properties of the silver coated glass beads are listed in Table 3. Some common properties of the nickel carbide are listed in Table 4. Some common properties of the carbon nanotubes are listed in Table 5.

TABLE 2

| | Example 4 | | Example 5 | | Example 6 | |
|---|---|---|---|---|---|---|
| second | polydimethyl- | | polydimethyl- | | polydimethyl- | |
| polysiloxane | siloxane (Shore | | siloxane (Shore | | siloxane (Shore | |
| polymeric | A 40 degrees) | | A 40 degrees) | | A 40 degrees) | |
| material | 40% | | 30% | | 40% | |
| (resistivity: | | | | | | |
| >10¹² ohm*cm) | | | | | | |
| curing agent | Platinum | | Platinum | | Platinum | |
| | curing agent: | | curing agent: | | curing agent: | |
| | catalyst 3% | | catalyst 3% | | catalyst 3% | |
| | crosslinking | | crosslinking | | crosslinking | |
| | 2.5% | | 2.5% | | 2.5% | |
| conductive | silver coated | | nickel carbide | | carbon | |
| additive | glass beads | | 64.5% | | nanotubes | |
| | 54.5% | | | | 54.5% | |
| Resistivity | 0.107 | ohm*cm | 0.146 | ohm*cm | 0.377 | ohm*cm |
| afterwards | | | | | | |
| (Shore A) | 60 | degrees | 70 | degrees | 65 | degrees |
| temperature | 120° C. | | 115° C. | | 130° C. | |
| pressure | 100 | kgf/cm² | 120 | kgf/cm² | 120 | kgf/cm² |
| time | 10 | minutes | 10 | minutes | 8 | minutes |

TABLE 3

| Conductive additive | Ag |
|---|---|
| Average particle size | 3-200 |
| (micrometer) | |
| density | 1.6-3.8 |
| Metal content (%) | Ag: 1-30 |
| Silver coated-thickness | 1.523~120 |
| (nanometer) | |
| silver coated glass beads | 5~80% |
| content | |

TABLE 4

| Conductive additive | NiC |
|---|---|
| Average particle size | 1-200 |
| (micrometer) | |
| density | 1.1-2.5 |
| Metal content (%) | Ni: 5-80 |

TABLE 5

| Conductive additive | carbon nanotubes |
|---|---|
| Average particle size | 1.2-2 |
| (nanometer) | |
| Average length | 100(nm)-4(μm) |
| volume resistivity(ohm*cm) | 10⁻³-10⁻⁶ |

The content of the curing agent may be 0.01 wt. %-10 wt. %, based on the total weight of the cured conductive elastomer, for example, a platinum curing agent. The platinum curing agent may be a combination of a first agent which includes platinum to serve as a catalyst agent and a second agent which includes siloxane to serve as a crosslinking agent. An optional filler may be added. The optional filler may be at least one of the materials selected from the group such as diatomite, titanium dioxide, aluminum oxide, boron nitride, aluminum nitride, zinc oxide, aluminum hydroxide, magnesium oxide, silicon oxide and silicone oil. The total content of the optional filler may be up to 80 wt. %, based on the total weight of the conductive elastomer.

The conductive connecting member may be prepared by curing the above-mention liquid conductive elastomer material and the solid insulating elastomer material. First, the preparation and the mixing of the ingredients are carried out in accordance with the requirements, properties of the products to formulate the above-mention liquid conductive elastomer material and the solid insulating elastomer material. Ingredients includes a solid polysiloxane polymeric material or a liquid polysiloxane polymeric material, a curing agent, a conductive additive or a filler. For instance, ingredients in example are listed in Table 6.

Next, a conventional mixing machine, such as a Kneader or a Roll Mill Machine, equipped with a thermocouple to measure the temperature of the ingredients during mixing is used. First, the prepared polysiloxane polymeric material is added. Then, the prepared filler, curing agent and conductive additive are added one by one. The order of the addition is not critical as long as the ingredients are uniformly mixed before the addition of another ingredient while the thermocouple is measuring the temperature to keep the temperature under a set value, for example 80° C., to avoid undesirable curing reaction taking place to cure the ingredients in advance during the mixing process. The mixing process may be temporarily stopped to lower the temperature before the continuation of the mixing process.

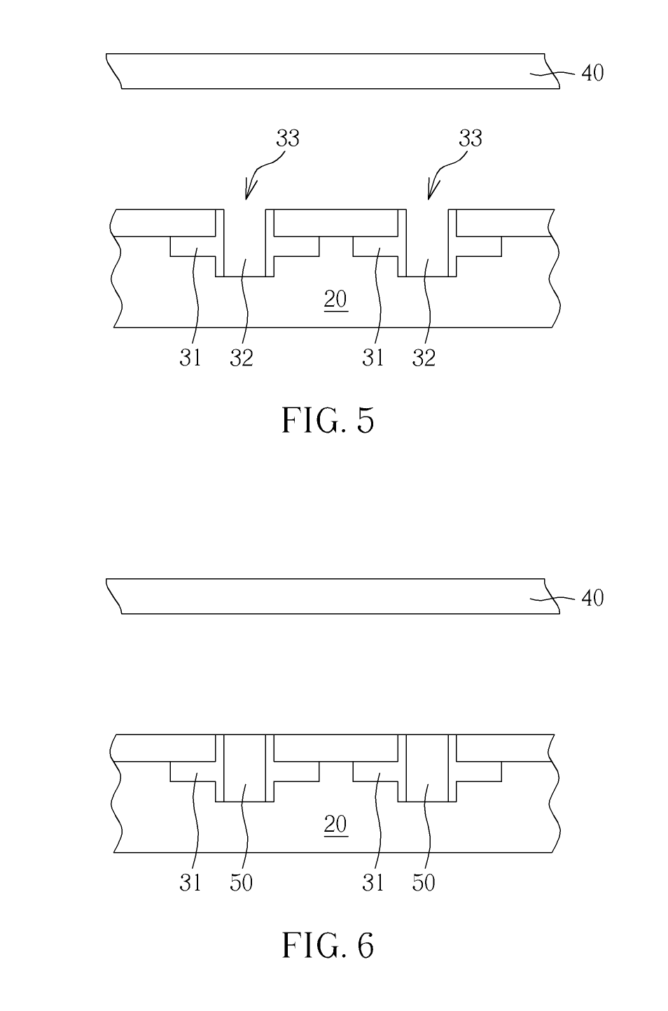

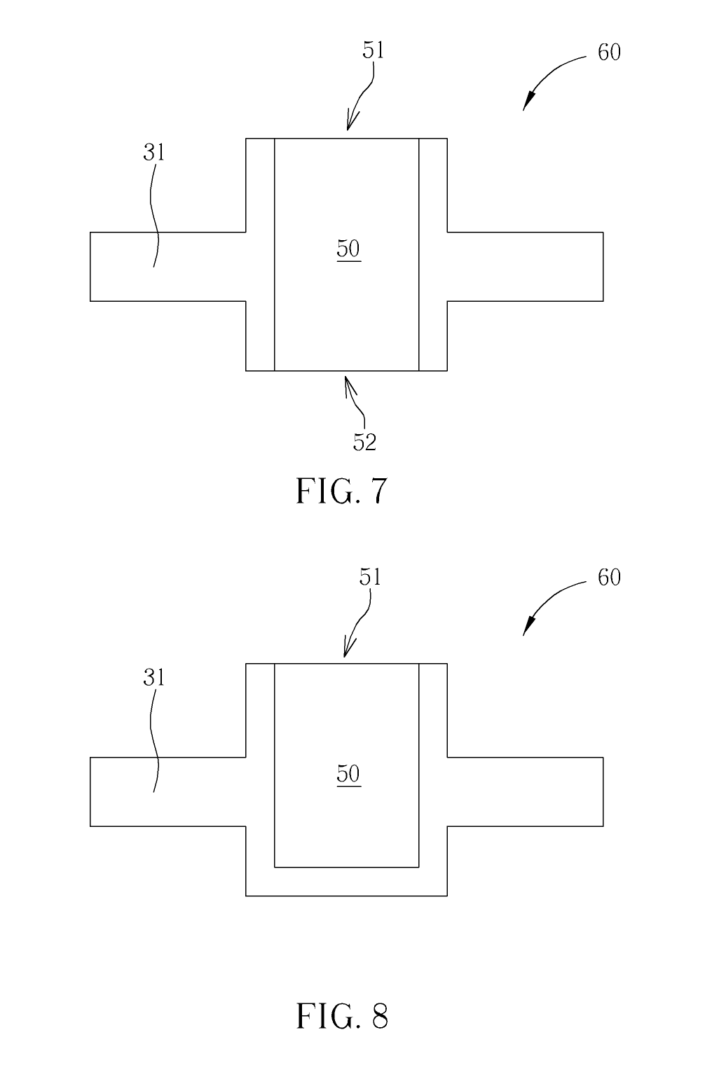

As shown in FIG. 5, to prepare the conductive elastomer, the thermally formed insulating elastomer 31, the bottom mold 20 and the top mold 40 are heated together to a temperature, such as 80° C. Then, as shown in FIG. 6, the liquid conductive elastomer material 50 is used to fill (partially or totally) at least one opening 33 and to fill up (totally) the cavity 32, preferably fill at least one opening 33 and to fill up all the cavities 32. The bottom mold 20 and the top mold 40 are pressed together under a temperature, a pressure and a period of time in a condition such as 80° C. to 220° C. and 20 kgf/cm²-200 kgf/cm², for example, a temperature of 80° C. and a pressure of 100 kgf/cm² for 5 minutes, then the top mold 40 is removed to obtain the formed conductive connecting member 60 with a liquid conductive elastomer 50 and an insulating elastomer 31 which are cured in different curing steps, as shown in FIG. 7 or in FIG. 8.

Because a liquid conductive elastomer 50 is used, an area of any opening 33 of the insulating elastomer 31 may be 50-0.5 mm². Any single surface area of the cured conductive elastomer 50 which is not covered by the insulating elastomer 31, such as the single surface 51 or 52, may be 50-0.5 mm², preferably 30-0.5 mm², more preferably 10-0.5 mm², particularly more preferably as small as 0.5 mm². In another embodiment of the present invention, the curing step illustrated in FIG. 4 may be optionally skipped. Instead, the liquid conductive elastomer 50 and the solid insulating elastomer 30 are cured at the same time to obtain the formed conductive connecting member 60.

The compositions of the liquid conductive elastomer and the solid insulating elastomer may be respectively adjusted to optimize the ideal properties of the conductive connecting member. For example, the conductive connecting member may have a Shore Hardness type A from 5 to 90 degrees or 10%˜20% compression set according to ASTM D 395.

The properties of the examples and the comparative example were evaluated by the following methods and the results are listed in Table 2 and in Table 6.

Measurement of Hardness:

The Shore Hardness type A was measured by Shore Durometer type A and the results are given in Table 6.

Measurement of Compression Set:

The thickness of the original sample was measured and a pressure was applied to keep a compression ratio of 25% at 70° C. for 22 hours. After that, the sample was taken out to allow the temperature back to room temperature to measure the thickness according to ASTM D 395. The compression set was calculated by the thickness of the sample before and after the test. The results are given in Table 6.

Measurement of Volume Resistivity:

The volume resistivity of the samples was measured by using a digital ohmmeter (Monroe 272A). The results are given in Table 2.

TABLE 6

| | | | | Comparative |
|---|---|---|---|---|
| | | | | Example |
| | | Example 7 | Example 8 | 1 |
| solid | solid | Solid | Solid | Foam |
| insulating | polysiloxane | polydimethyl- | polyvinyl- | covered |
| elastomer | material | siloxane | methylsiloxane | electrically |
| material | | (Shore A 40 | (Shore A 30 | conductive |
| | | deg) 6 g | deg) 6 g | fabric |
| | filler | Silicon | Silicon | (Cofortune |
| | | dioxide 3.45 g | dioxide 3 g | Technology |
| | curing agent | Platinum | benzoperoxide | Inc. FG |
| | | curing agent: | 1 g | series) |
| | | catalyst 0.3 g | | |
| | | crosslinking | | |
| | | 0.25 g | | |
| liquid | liquid | liquid | liquid | |
| conducting | polysiloxane | polydimethyl- | polyvinyl- | |
| elastomer | material | siloxane 5.45 g | methylsiloxane | |
| material | | | 4 g | |
| | filler | — | silicon oxide | |
| | | | 1 g | |
| | conductive | nickel | carbon | |
| | additive | carbide 4 g | nanotubes | |
| | | | 4.2 g | |
| | curing agent | Platinum | benzoperoxide | |
| | | curing agent: | 0.8 g | |
| | | catalyst 0.3 g | | |
| | | crosslinking | | |
| | | 0.25 g | | |

| | | | |
|---|---|---|---|
| compression set | 16% | 18% | 24% |

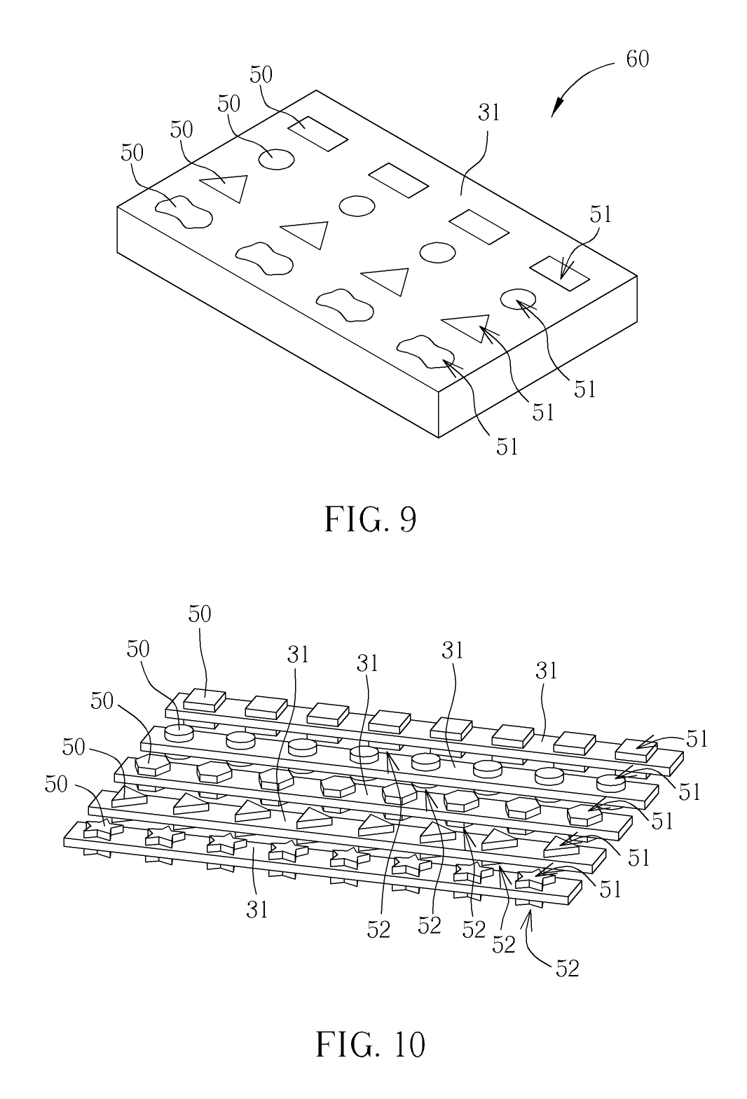

After the above steps, a product of conductive connecting member 60 is obtained, as shown in FIG. 7, FIG. 8 or FIG. 9. A product of conductive connecting member 60 includes a cured conductive elastomer 50 and a cured insulating elastomer 31. The cured insulating elastomer 31 includes a first silicone-rubber-based material. The first silicone-rubber-based material includes a solid polysiloxane polymeric material serving as a substrate, a curing agent, and an optional filler. The cured conductive elastomer 50 includes a conductive additive and a second silicone-rubber-based material. The second silicone-rubber-based material includes a second polysiloxane polymeric material, a platinum curing agent, and an optional filler. In a product of conductive connecting member 60, a cured conductive elastomer 50 is attached to a cured insulating elastomer 31. Preferably, a cured conductive elastomer 50 may have up to 4 surfaces which are not covered by a cured insulating elastomer 31 by means of different filling of the liquid conductive elastomer. Any single surface area of the cured conductive elastomer 50 which is not covered by the insulating elastomer 31, such as the single surface 51 or 52 in FIG. 7 or 8, may be 50-0.5 mm², preferably 30-0.5 mm², more preferably 10-0.5 mm², particularly more preferably as small as 0.5 mm², as the examples in Table 7.

TABLE 7
Single surface area of cured conductive elastomer 50 which
is not covered by insulating elastomer 31

| | Example 4 | Example 5 | Example 6 |
|---|---|---|---|
| area of one | 45 mm² | 20 mm² | 0.5 mm² |
| opening | | | |
| single surface | 42.8 mm² | 18.5 mm² | 0.52 mm² |
| area not covered | | | |
| by insulating | | | |
| elastomer | | | |

Please see the above descriptions for the ingredients in the conductive elastomer 50 and in the insulating elastomer 31. When a second silicone-rubber-based material of higher electric resistivity is mixed with a conductive additive of extreme low electric resistivity, an elastomer material of low electric resistivity is obtained. For example, the electrically insulating elastomer or the second silicone-rubber-based material has a volume resistivity greater than 10¹² ohm*cm. But the electrically conducting elastomer has a volume resistivity less than 0.5 ohm*cm due to the presence of the conductive additive to change the physical properties of the second silicone-rubber-based material.

In another embodiment of the present invention, the insulating elastomer 31 in the conductive connecting member 60 is in a form of a long strip and the conductive elastomer 50 is disposed on the insulating elastomer 31 to be in a form of a plurality of isolated island-like units. Preferably, the conductive elastomers 50 of the conductive connecting member 60 are on a surface of the insulating elastomer 31 and of different shapes, as shown in FIG. 10.

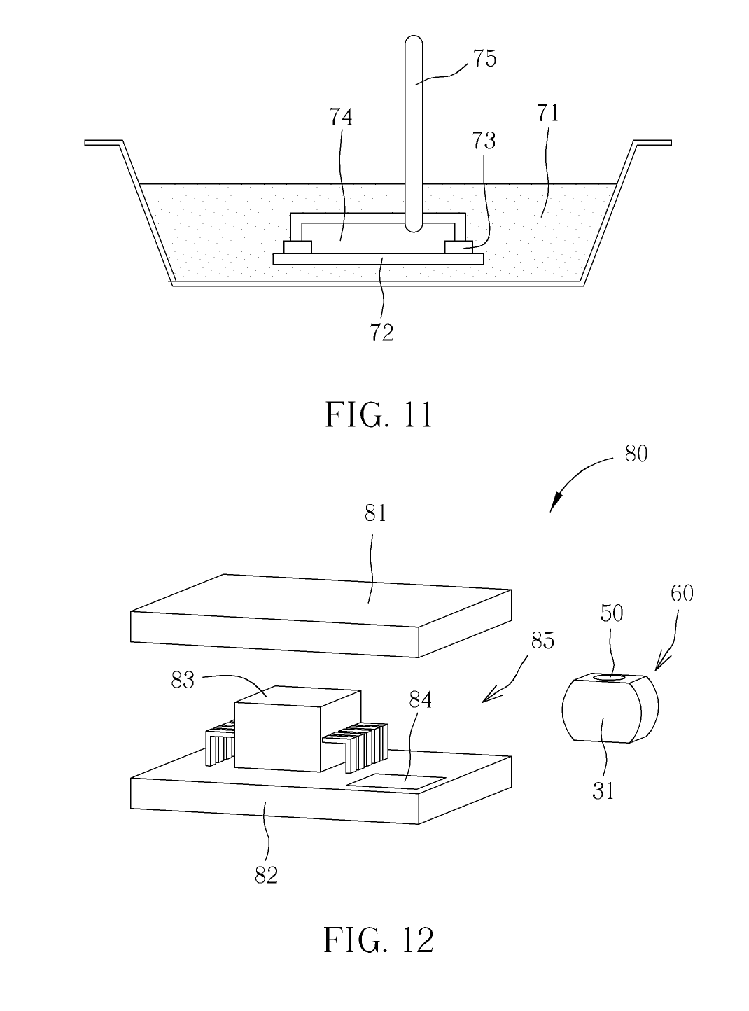

The conductive connecting member 60 of the present invention is water-resistant. The water-resistant ability is measured by the installation as shown in FIG. 11. A water-resistant partition, such as a stainless steel or a polyethene plastic, is used to form an enclosed space with the sample conductive connecting member. As the air pressure is up to 0.1 kgf/cm², no bubbles are observed. The test results are given in Table 8. Because the compression set according to ASTM D 395 is 10%˜20%, The conductive connecting member 60 of the present invention is capable of remaining good resilience and is water-resistant after long term use.

Water-Resistant Test

An installation to carry out the test is shown in FIG. 11. A water-resistant partition 72, such as a stainless steel or a polyethene plastic, and the sample 73 are used to form an enclosed space 74 with a duct 75. The container 71 has water and the air pressure 0.1 kgf/cm² is applied to the space 74. Water-resistance is determined if there are bubbles are observed on the sample 73 or on its periphery.

TABLE 8

| | | | electrically conductive fabric | | |
|---|---|---|---|---|---|
| | electrically | | covered foam (Cofortune | | |
| | conductive | | Technology Inc. FG series) | | |
| | connecting member | | Com- | Com- | Com- |
| | Example | Example | parative | parative | parative |
| | 7 | 8 | example 2 | example 3 | example 4 |
| results | pass | pass | failed | failed | failed |

Next, a method for using an electrically conductive connecting member is provided. The conductive connecting member of the present invention is suitable to fill a gap in an electronic part set and plays a role to be water-resistant and electrically conductive.

First, as shown in FIG. 12, an electrically conductive connecting member 60 and an electronic part set 80 having a gap 85 are provided. Please refer to the above descriptions for the details of the electrically conductive connecting member 80. The electrically conductive connecting member 80 is not limited to plates, so it may have various shapes. Both the conductive elastomer 50 and the insulating elastomer 31 include a silicone-based material so the electrically conductive connecting member 60 including the two is elastic enough.

The electronic part set 80 is a collection of electronic parts to perform specific functions, such as an electronic part set in a computer. The electronic part set 80 may include a top plate 81, a bottom plate 82, a first part 83, a second part 84, and a gap 85, usually disposed on a motherboard. Because the first part 83 and the second part 84 are located on different places on the motherboard, there may be various gaps 85 of different sizes and shapes.

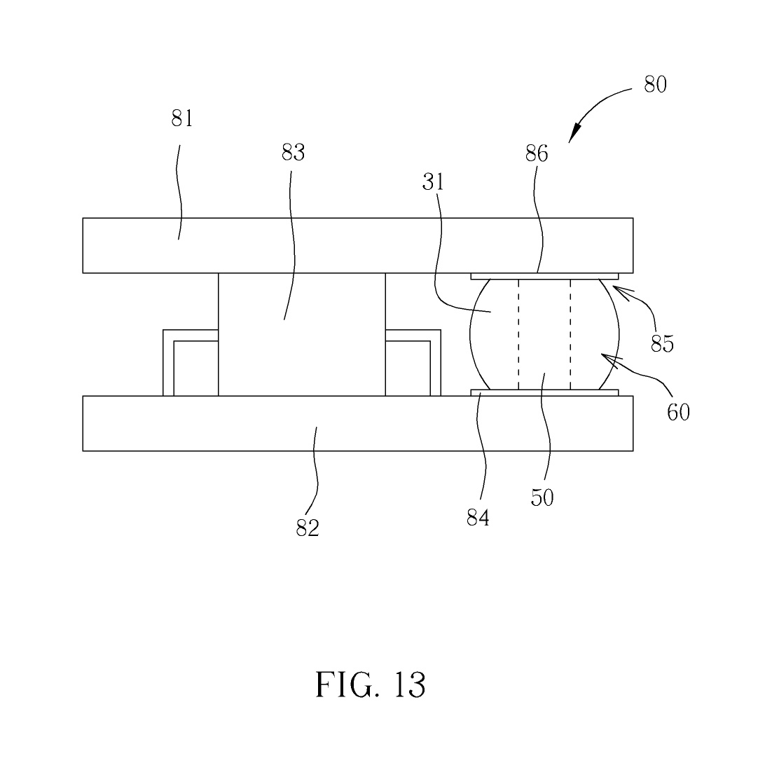

Then, as shown in FIG. 13, an electrically conductive connecting member 60 of a suitable size and shape is used. The electrically conductive connecting member 60 is pressed in to the gap 85 to partially or totally fill the gaps 85. FIG. 13 illustrates an example that the electrically conductive connecting member 60 partially fill a room occupied by the gap 85 and remains some of the gap 85 unfilled.

The conductive elastomer 50 may fill the opening of the insulating elastomer 31 differently so a single surface area of the conductive elastomer 50 which is not covered by the insulating elastomer 31, such as the single surface 51 or 52, may be 50-0.5 mm², preferably 30-0.5 mm², more preferably 10-0.5 mm², particularly more preferably as small as 0.5 mm².

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrically conductive connecting member, comprising:
an electrically insulating elastomer having a cavity and at least one opening and comprising:
a first silicone-rubber-based material, comprising 99.99 wt. %-10 wt. % of a first polysiloxane and 0.01 wt. %-10 wt. % of a curing agent, based on the total weight of said electrically insulating elastomer, wherein said at least one opening has an area of 50-0.5 mm²; and
an electrically conducting elastomer filling said at least one opening, filling up said cavity and comprising:
a second silicone-rubber-based material, comprising 94.99 wt. %-10 wt. % of a second polysiloxane material, and 0.01 wt. %-10 wt. % of a platinum curing agent; and
5 wt. %-80 wt. % of a conductive additive, based on the total weight of said electrically conducting elastomer.

2. The electrically conductive connecting member of claim 1, wherein said curing agent comprises at least one of a platinum curing agent and a peroxide curing agent.

3. The electrically conductive connecting member of claim 1, wherein said first silicone-rubber-based material further comprises at least one of diatomite, titanium dioxide, aluminum oxide, boron nitride, aluminum nitride, zinc oxide, aluminum hydroxide, magnesium oxide, silicon oxide and silicone oil.

4. The electrically conductive connecting member of claim 1, wherein said second silicone-rubber-based material further comprises at least one of diatomite, titanium dioxide, aluminum oxide, boron nitride, aluminum nitride, zinc oxide, aluminum hydroxide, magnesium oxide, silicon oxide and silicone oil.

5. The electrically conductive connecting member of claim 1, wherein said conductive additive comprises at least one of silver coated glass beads, nickel carbide and carbon nanotubes.

6. The electrically conductive connecting member of claim 1, wherein said electrically insulating elastomer has a volume resistivity greater than 10¹² ohm*cm and said electrically conducting elastomer has a volume resistivity less than 0.5 ohm*cm.

7. The electrically conductive connecting member of claim 1, wherein said electrically conducting elastomer which is not surrounded by said electrically insulating elastomer has a single side surface area of 50-0.5 mm².

8. The electrically conductive connecting member of claim 1 of a Shore Hardness type A from 5 to 90 degrees.

9. The electrically conductive connecting member of claim 1, wherein said electrically insulating elastomer is in a form of a long strip and said electrically conducting elastomer is in a form of a plurality of isolated island-like units.

10. The electrically conductive connecting member of claim 1, of 10%-20% compression set according to ASTM D 395.

11. The electrically conductive connecting member of claim 1, of a water-resistant ability up to 0.1 kgf/cm².

12. A method for forming an electrically conductive connecting member, comprising:
providing a solid electrically insulating elastomer material comprising a first silicone-rubber-based material comprising a solid polysiloxane material;
providing a liquid electrically conducting elastomer material comprising a conductive additive and a second silicone-rubber-based material which comprises a liquid polysiloxane material; and
curing said liquid electrically conducting elastomer material to attach said liquid electrically conducting elastomer material to said solid electrically insulating elastomer material to obtain an electrically conductive connecting member.

13. The method of claim 12, wherein said first silicone-rubber-based material further comprises at least one of a platinum curing agent and a peroxide curing agent.

14. The method of claim 12, wherein said first silicone-rubber-based material further comprises at least one of diatomite, titanium dioxide, aluminum oxide, boron nitride, aluminum nitride, zinc oxide, aluminum hydroxide, magnesium oxide, silicon oxide and silicone oil.

15. The method of claim 12, wherein said second silicone-rubber-based material further comprises 0.01 wt. %-10 wt. % of a platinum curing agent, based on the total weight of said electrically conducting elastomer material.

16. The method of claim 12, wherein said second silicone-rubber-based material further comprises at least one of diatomite, titanium dioxide, aluminum oxide, boron nitride, aluminum nitride, zinc oxide, aluminum hydroxide, magnesium oxide, silicon oxide and silicone oil.

17. The method of claim 12, further comprising:
compounding said second silicone-rubber-based material to be said liquid electrically conducting elastomer material.

18. The method of claim 12, wherein said conductive additive comprises at least one of silver coated glass beads, nickel carbide and carbon nanotubes.

19. The method of claim 12, further comprising:
curing said solid electrically insulating elastomer material under a temperature of 80° C. to 220° C. and a pressure of 20 kgf/cm²-200 kgf/cm² to obtain an electrically insulating elastomer comprising a cavity and at least one opening which has an area of 50-0.5 mm².

20. The method of claim 19, wherein said liquid electrically conducting elastomer material fills said at least one opening and fills up said cavity.

21. The method of claim 12, wherein curing said liquid electrically conducting elastomer material is carried out under a temperature of 80° C. to 220° C. and a pressure of 20 kgf/cm²-200 kgf/cm² so that said liquid electrically conducting elastomer material is attached to said electrically insulating elastomer.

22. A method for using an electrically conductive connecting member, comprising:
providing an electrically conductive connecting member, comprising:
an electrically insulating elastomer having a cavity and at least one opening and comprising:
a first silicone-rubber-based material, comprising 99.99 wt. %-10 wt. % of a first polysiloxane and 0.01 wt. %-10 wt. % of a curing agent based on the total weight of said electrically insulating elastomer, wherein said at least one opening has an area of 50-0.5 mm²; and
an electrically conducting elastomer filling said at least one opening, filling up said cavity and comprising:
a second silicone-rubber-based material, comprising 94.99 wt. %-10 wt. % of a second polysiloxane material, 0.01 wt. %-10 wt. % of a platinum curing agent and 5 wt. %-80 wt. % of a conductive additive based on the total weight of said electrically conducting elastomer;
providing an electronic part set having a gap; and
pressing said electrically conductive connecting member into said gap to fill said gap.

23. The method of claim 22, wherein said conductive additive comprises at least one of silver coated glass beads, nickel carbide and carbon nanotubes.

24. The method of claim 22, wherein said electrically conductive connecting member has a water-resistant ability up to 0.1 kgf/cm².

25. The method of claim 22, wherein said electrically conductive connecting member has 10%˜20% compression set according to ASTM D 395.

26. The method of claim 22, wherein said electrically conducting elastomer which is not surrounded by said electrically insulating elastomer has a single side surface area of 50-0.5 mm².

27. The method of claim 22, wherein a contact area of said electrically conducting elastomer in contact with said electronic part set is at least 0.5 mm² when said electrically conductive connecting member fills said gap.
